(19) United States
(12) Patent Application Publication
(10) Pub. No.: US 2015/0288949 A1
(43) Pub. Date: Oct. 8, 2015

(54) IMAGE GENERATING APPARATUS, IMAGING APPARATUS, AND IMAGE GENERATING METHOD

(71) Applicant: PANASONIC INTELLECTUAL PROPERTY MANAGEMENT CO., LTD., Osaka (JP)

(72) Inventors: Kenichi KUBOTA, Osaka (JP); Yoshihiro MORIOKA, Nara (JP); Yusuke ONO, Osaka (JP); Toshiyuki NAKASHIMA, Hyogo (JP)

(21) Appl. No.: 14/726,445

(22) Filed: May 29, 2015

Related U.S. Application Data
(63) Continuation of application No. PCT/JP2014/001277, filed on Mar. 7, 2014.

(30) Foreign Application Priority Data
Mar. 11, 2013 (JP) 2013-047491

(51) Int. Cl. H04N 13/02; H04N 13/00

(52) U.S. Cl. CPC H04N 13/025; H04N 13/0239; H04N 13/004

(57) ABSTRACT

An imaging apparatus includes a primary imaging section, a secondary imaging section configured to output a secondary image signal that has an angle of view wider than or equal to that of the primary image and a resolution higher than or equal to that of the primary image, an angle-of-view adjusting unit configured to generate a cutout image signal from the secondary image signal based on the primary image signal, an interpolation pixel generating unit configured to generate an interpolation pixel, a parallax information generating unit configured to generate parallax information based on the primary image signal whose resolution is increased using the interpolation pixel and the cutout image signal, and an image generating unit configured to, based on the parallax information, generate a new image signal from the primary image signal whose resolution is increased.

### BACKGROUND

1. Field of the Disclosure

The present disclosure relates to an imaging apparatus that includes a plurality of imaging units and can capture an image for stereoscopic vision.

2. Background Art

Unexamined Japanese Patent Publication No. 2005-20606 (Patent Literature 1) discloses a digital camera that includes a main imaging unit and a sub imaging unit and generates a 3D image. This digital camera extracts parallax occurring between a main image signal obtained from the main imaging unit and a sub image signal obtained from the sub imaging unit. Based on the extracted parallax, a new sub image signal is generated from the main image signal, and a 3D image is generated from the main image signal and new sub image signal.

Unexamined Japanese Patent Publication No. 2005-210217 (Patent Literature 2) discloses a stereo camera that can perform stereoscopic photographing in a state where the right and left photographing magnifications are different from each other. This stereo camera includes a primary imaging means for generating primary image data, and a secondary imaging means for generating secondary image data whose angle of view is wider than that of the primary image data. The stereo camera cuts out, as third image data, a range corresponding to the primary image data from the secondary image data, and generates stereo image data from the primary image data and third image data.

Patent Literature 1 and Patent Literature 2 disclose a configuration where the main imaging unit (primary imaging means) has an optical zoom function and the sub imaging unit (secondary imaging means) does not have an optical zoom function but has an electronic zoom function.

### SUMMARY

The present disclosure provides an image generating apparatus and imaging apparatus that are useful for obtaining a high-quality image or moving image for stereoscopic vision from a pair of images or a pair of moving images that are captured by a pair of imaging sections having different optical characteristics and different specifications of imaging elements.

The image generating apparatus of the present disclosure includes an angle-of-view adjusting unit, an interpolation pixel generating unit, a parallax information generating unit, and an image generating unit. The angle-of-view adjusting unit is configured to receive a primary image signal and a secondary image signal having a resolution higher than a resolution of the primary image signal and an angle of view wider than or equal to an angle of view of the primary image signal and to, based on the primary image signal, cut out at least a part of the secondary image signal and generate a cutout image signal. The interpolation pixel generating unit is configured to generate an interpolation pixel for increasing the resolution of the primary image signal. The parallax information generating unit is configured to generate parallax information based on the primary image signal, whose resolution is increased using the interpolation pixel, and the cutout image signal. The image generating unit is configured to, based on the parallax information, generate a new image signal from the primary image signal whose resolution is increased.

The imaging apparatus of the present disclosure includes a primary imaging section, a secondary imaging section, an angle-of-view adjusting unit, an interpolation pixel generating unit, a parallax information generating unit, and an image generating unit. The primary imaging section is configured to capture a primary image and output a primary image signal. The secondary imaging section is configured to capture a secondary image having an angle of view wider than or equal to that of the primary image at a resolution higher than that of the primary image, and output a secondary image signal. The angle-of-view adjusting unit is configured to, based on the primary image signal, cut out at least a part of the secondary image signal and generate a cutout image signal. The interpolation pixel generating unit is configured to generate an interpolation pixel for increasing the resolution of the primary image signal. The parallax information generating unit is configured to generate parallax information based on the primary image signal, whose resolution is increased using the interpolation pixel, and the cutout image signal. The image generating unit is configured to, based on the parallax information, generate a new image signal from the primary image signal whose resolution is increased.

The imaging apparatus of the present disclosure further includes an interpolation frame generating unit. The primary imaging section is configured to output the primary image signal as a video signal. The secondary imaging section is configured to output the secondary image signal as a video signal having a resolution higher than that of the primary image signal and a frame rate lower than that of the primary image signal. The interpolation frame generating unit is configured to generate an interpolation frame for increasing the frame rate of the cutout image signal. The parallax information generating unit is configured to generate parallax information based on the primary image signal whose resolution is increased and the cutout image signal whose frame rate is increased using the interpolation frame.

The image generating method of the present disclosure includes:
cutting out at least a part from a secondary image signal and generating a cutout image signal based on a primary image signal, the secondary image signal having a resolution higher than a resolution of the primary image signal and an angle of view wider than or equal to an angle of view of the primary image signal;
generating an interpolation pixel for increasing the resolution of the primary image signal;
generating parallax information based on the primary image signal, whose resolution is increased using the interpolation pixel, and the cutout image signal; and
generating, based on the parallax information, a new image signal from the primary image signal whose resolution is increased.

### BRIEF DESCRIPTION OF DRAWINGS

FIG. 1 is an outward appearance of an imaging apparatus in accordance with a first exemplary embodiment.

FIG. 2 is a diagram schematically showing a circuit configuration of the imaging apparatus in accordance with the first exemplary embodiment.

FIG. 3 is a flowchart illustrating the operation when stereoscopic video is shot by the imaging apparatus in accordance with the first exemplary embodiment.

FIG. 4 is a diagram showing the configuration of the imaging apparatus in accordance with the first exemplary embodiment while each function is shown by each block.

FIG. 5 is a diagram schematically showing one example of the processing flow of an image signal in the imaging apparatus in accordance with the first exemplary embodiment.

FIG. 6A is a diagram showing one example of a primary image captured by the imaging apparatus in accordance with the first exemplary embodiment.

FIG. 6B is a diagram showing one example of a secondary image captured by the imaging apparatus in accordance with the first exemplary embodiment.

FIG. 7 is a diagram schematically showing the difference between the pixel generation times of the primary image and secondary image that are captured by the imaging apparatus in accordance with the first exemplary embodiment.

### DETAILED DESCRIPTION

Hereinafter, the exemplary embodiments will be described in detail appropriately with reference to the accompanying drawings. Description more detailed than necessary is sometimes omitted. For example, a detailed description of a well-known item and a repeated description of substantially the same configuration are sometimes omitted. This is for the purpose of preventing the following descriptions from becoming more redundant than necessary and allowing persons skilled in the art to easily understand the exemplary embodiments.

The accompanying drawings and the following descriptions are provided to allow the persons skilled in the art to sufficiently understand the present disclosure. It is not intended that they restrict the main subject described within the scope of the claims.

### First Exemplary Embodiment

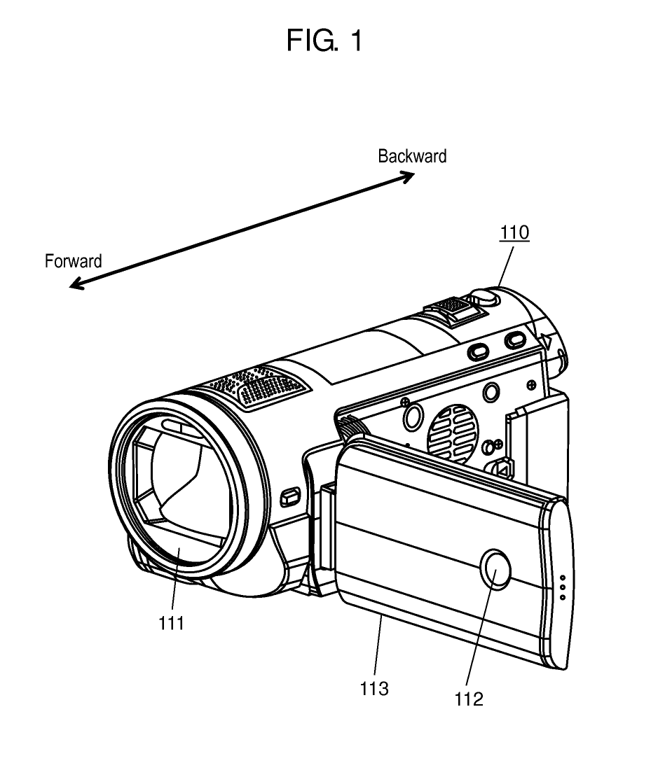

The first exemplary embodiment is hereinafter described using FIG. 1 to FIG. 7.

[1-1. Configuration]

FIG. 1 is an outward appearance of imaging apparatus 110 in accordance with the first exemplary embodiment. Imaging apparatus 110 includes monitor 113, an imaging section (hereinafter referred to as “primary imaging section”) including primary lens unit 111, and an imaging section (hereinafter referred to as “secondary imaging section”) including secondary lens unit 112. Imaging apparatus 110 thus includes a plurality of imaging sections, and each imaging section can capture a still image and shoot a video.

Primary lens unit 111 is disposed in a front part of the main body of imaging apparatus 110 so that the imaging direction of the primary imaging section is the forward direction.

Monitor 113 is openably/closably disposed in the main body of imaging apparatus 110, and includes a display (not shown in FIG. 1) for displaying a captured image. The display is disposed on the surface of monitor 113 that is on the opposite side to the imaging direction of the primary imaging section when monitor 113 is open, namely on the side on which a user (not shown) staying at the back of imaging apparatus 110 can observe the display.

Secondary lens unit 112 is disposed on the side of monitor 113 opposite to the installation side of the display, and is configured to face the same direction as the imaging direction of the primary imaging section when monitor 113 is open.

In imaging apparatus 110, the primary imaging section is set as a main imaging section, and the secondary imaging section is set as a sub imaging section. As shown in FIG. 1, when monitor 113 is open, using the two imaging sections allows the capturing of a still image for stereoscopic vision (hereinafter referred to as “stereoscopic image”) and the shooting of video for stereoscopic vision (hereinafter referred to as “stereoscopic video”). The primary imaging section as the main imaging section has an optical zoom function. The user can set the zoom function at any zoom magnification, and perform the still image capturing or video shooting.

In the present exemplary embodiment, an example is described where the primary imaging section captures an image of right-eye view and the secondary imaging section captures an image of left-eye view. Therefore, as shown in FIG. 1, in imaging apparatus 110, primary lens unit 111 is disposed on the right side of the imaging direction and secondary lens unit 112 is disposed on the left side of the imaging direction. The present exemplary embodiment is not limited to this configuration. A configuration may be employed in which the primary imaging section captures an image of left-eye view and the secondary imaging section captures an image of right-eye view. Hereinafter, an image captured by the primary imaging section is referred to as “primary image”, and an image captured by the secondary imaging section is referred to as “secondary image”.

Secondary lens unit 112 of the secondary imaging section as the sub imaging section has an aperture smaller than that of primary lens unit 111, and does not have an optical zoom function. Therefore, the installation volume required by the secondary imaging section is smaller than that of the primary imaging section, so that the secondary imaging section can be mounted on monitor 113.

In the present exemplary embodiment, the image of right-eye view captured by the primary imaging section is not used, as it is, as a right-eye image constituting a stereoscopic image, and the image of left-eye view captured by the secondary imaging section is not used as a left-eye image constituting the stereoscopic image. In the present exemplary embodiment, the image quality of each of the primary image captured by the primary imaging section and the secondary image captured by the secondary imaging section is improved, the parallax amount is calculated by comparing the images after the improvement of the image quality with each other, and a stereoscopic image is generated based on the calculated parallax amount (the details are described later).

The parallax amount means the magnitude of the positional displacement of a subject that occurs when the primary image and secondary image are overlaid on each other at the same angle of view. This displacement is caused by the difference (parallax) between the disposed position of the primary imaging section and that of the secondary imaging section. In order to generate a stereoscopic image that produces a natural stereoscopic effect, preferably, the optical axis of the primary imaging section and the optical axis of the secondary imaging section are set so as to be horizontal to the ground—like the parallax direction of persons—and so as to separate from each other by a similar extent to the width between the right eye and left eye.

Therefore, in imaging apparatus 110, primary lens unit 111 and secondary lens unit 112 are disposed so that the optical centers thereof are located on substantially the same horizontal plane (plane horizontal to the ground) when the user normally holds imaging apparatus 110 (holds it in a stereoscopic image capturing state). The disposed positions of primary lens unit 111 and secondary lens unit 112 are set so that the distance between the optical centers thereof is 30 mm or more and 65 mm or less.

In order to generate a stereoscopic image that produces a natural stereoscopic effect, preferably, the distance between the disposed position of primary lens unit 111 and the subject is substantially the same as that between the disposed position of secondary lens unit 112 and the subject. Therefore, in imaging apparatus 110, primary lens unit 111 and secondary lens unit 112 are disposed so as to substantially satisfy the epipolar constraint. In other words, primary lens unit 111 and secondary lens unit 112 are disposed so that each optical center is located on one plane substantially parallel with the imaging surface of the imaging element that is included in the primary imaging section or the imaging element that is included in the secondary imaging section.

These conditions do not need to be strictly satisfied, but an error is allowed within a range where no problem arises in practical use. Even if these conditions are not satisfied, the image at this time can be converted into an image satisfying the conditions by executing affine transformation. In the affine transformation, the scaling, rotation, or parallel shift of an image is performed by calculation. The parallax amount is calculated using the image having undergone the affine transformation.

In imaging apparatus 110, primary lens unit 111 and secondary lens unit 112 are disposed so that the optical axis of the primary imaging section and the optical axis of the secondary imaging section are parallel with each other (hereinafter referred to as “parallel method”). However, primary lens unit 111 and secondary lens unit 112 may be disposed so that the optical axis of the primary imaging section and the optical axis of the secondary imaging section cross each other at one predetermined point (hereinafter referred to as “cross method”). The image captured by the parallel method can be converted, by the affine transformation, into an image that looks as if it were captured by the cross method.

Regarding the primary image and secondary image that are captured in a state where these conditions are satisfied, the position of the subject substantially satisfies the epipolar constraint condition. In this case, in the generating process of a stereoscopic image (described later), when the position of the subject is determined based on one image (e.g. primary image), the position of the subject determined based on the other image (e.g. secondary image) can be relatively easily calculated. Therefore, the operation amount can be reduced in the generating process of the stereoscopic image. Conversely, as the number of items that do not satisfy the conditions increases, the operation amount of the affine transformation or the like increases. Therefore, the operation amount increases in the generating process of the stereoscopic image.

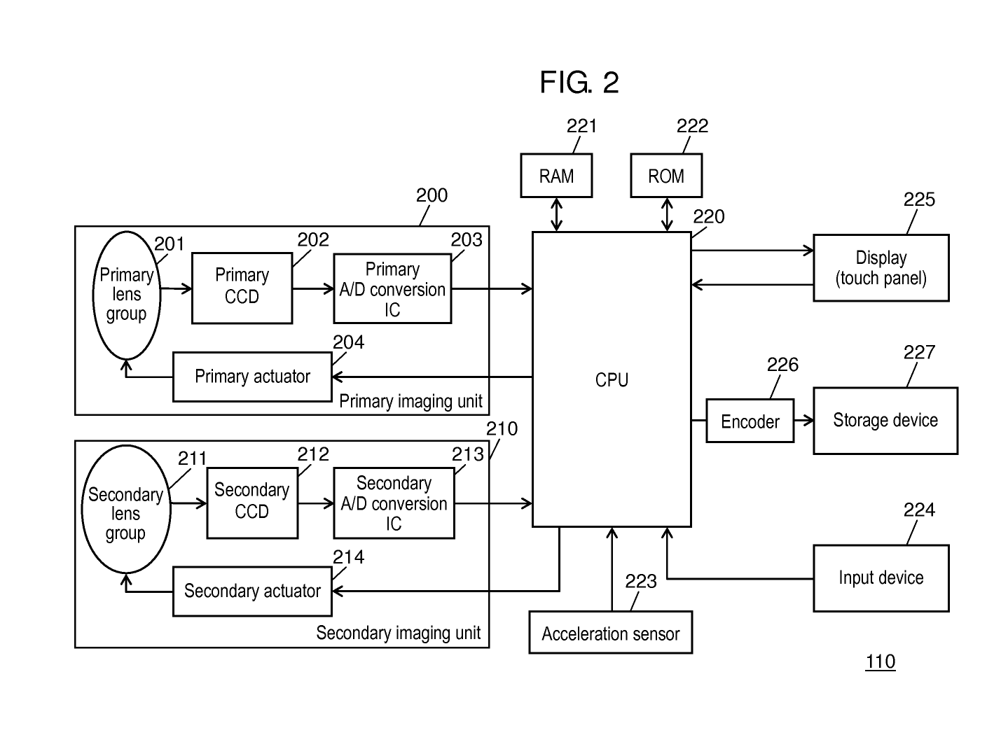

FIG. 2 is a diagram schematically showing a circuit configuration of imaging apparatus 110 in accordance with the first exemplary embodiment.

Imaging apparatus 110 includes primary imaging unit 200 as the primary imaging section, secondary imaging unit 210 as the secondary imaging section, CPU (central processing unit) 220, RAM (random access memory) 221, ROM (read only memory) 222, acceleration sensor 223, display 225, encoder 226, storage device 227, and input device 224.

Primary imaging unit 200 includes primary lens group 201, primary CCD (charge coupled device) 202 as a primary imaging element, primary A/D conversion IC (integrated circuit) 203, and primary actuator 204.

Primary lens group 201 corresponds to primary lens unit 111 shown in FIG. 1, and is an optical system formed of a plurality of lenses that include a zoom lens allowing optical zoom and a focus lens allowing focus adjustment. Primary lens group 201 includes an optical diaphragm (not shown) for adjusting the quantity of light (light quantity) received by primary CCD 202. The light taken through primary lens group 201 is formed as a subject image on the imaging surface of primary CCD 202 after the adjustments of optical zoom, focus, and light quantity are performed by primary lens group 201. This image is the primary image.

Primary CCD 202 is configured to convert the light having been received on the imaging surface into an electric signal and output it. This electric signal is an analog signal whose voltage value varies depending on the intensity of light (light quantity).

Primary A/D conversion IC 203 is configured to convert, into a digital electric signal, the analog electric signal output from primary CCD 202. The digital signal is the primary image signal.

Primary actuator 204 includes a motor configured to drive the zoom lens and focus lens that are included in primary lens group 201. This motor is controlled with a control signal output from CPU 220.

In the present exemplary embodiment, the following description is performed assuming that primary imaging unit 200 converts the primary image into the image signal “the number of horizontal pixels is 1,920 and the number of vertical pixels is 1,080”. Primary imaging unit 200 is configured to perform not only still image capturing but also video shooting, and can perform the video shooting at a frame rate (e.g. 60 Hz) similar to that of general video. Therefore, primary imaging unit 200 can shoot high-quality and smooth video. Here, the frame rate means the number of images captured in a unit time (e.g. 1 sec). When the video shooting is performed at a frame rate of 60 Hz, 60 images are continuously captured per second.

The number of pixels in the primary image and the frame rate during the video shooting are not limited to the above-mentioned numerical values. Preferably, they are set appropriately depending on the specification or the like of imaging apparatus 110.

Secondary imaging unit 210 includes secondary lens group 211, secondary CCD 212 as a secondary imaging element, secondary A/D conversion IC 213, and secondary actuator 214.

Secondary lens group 211 corresponds to secondary lens unit 112 shown in FIG. 1, and is an optical system that is formed of a plurality of lenses including a focus lens allowing focus adjustment. The light taken through secondary lens group 211 is formed as a subject image on the imaging surface of secondary CCD 212 after the adjustment of focus is performed by secondary lens group 211. This image is the secondary image.

Secondary lens group 211 does not have an optical zoom function, as discussed above. Therefore, secondary lens group 211 does not have an optical zoom lens but has a single focus lens. Secondary lens group 211 is also formed of a lens group smaller than primary lens group 201, and the objective lens of secondary lens group 211 has an aperture smaller than that of the objective lens of primary lens group 201. Thus, secondary imaging unit 210 is made smaller than primary imaging unit 200 and whole imaging apparatus 110 is downsized, and hence the convenience (portability or operability) is improved and the degree of freedom in the disposed position of secondary imaging unit 210 is increased. Thus, as shown in FIG. 1, secondary imaging unit 210 can be mounted on monitor 113.

Secondary CCD 212 is configured to convert the light having been received on the imaging surface into an analog electric signal and output it, similarly to primary CCD 202. Secondary CCD 212 of the present exemplary embodiment has a resolution higher than that of primary CCD 202. Therefore, the image signal of the secondary image has a resolution higher than that of the image signal of the primary image, and has more pixels than that of the image signal of the primary image. This is for the purpose of extracting and using a part of the image signal of the secondary image. The details are described later.

Secondary A/D conversion IC 213 is configured to convert, into a digital electric signal, the analog electric signal output from secondary CCD 212. This digital signal is the secondary image signal.

Secondary actuator 214 includes a motor that is configured to drive the focus lens included in secondary lens group 211. This motor is controlled by a control signal output from CPU 220.

In the present exemplary embodiment, the following description is performed assuming that secondary imaging unit 210 converts the secondary image into the image signal “the number of horizontal pixels is 7,680 and the number of vertical pixels is 4,320”. Similarly to primary imaging unit 200, secondary imaging unit 210 is configured to perform not only still image capturing but also video shooting. However, since the secondary image signal has a resolution higher than that of the primary image signal and has more pixels than that of the primary image signal, the frame rate (e.g. 30 Hz) during the video shooting by secondary imaging unit 210 is lower than the frame rate during the video shooting by primary imaging unit 200.

The number of pixels in the secondary image and the frame rate during the video shooting are not limited to the above-mentioned numerical values. Preferably, they are set appropriately depending on the specification or the like of imaging apparatus 110.

In the present exemplary embodiment, a series of operations in which the subject image formed on the imaging surface of an imaging element is converted into an electric signal and the electric signal is output as an image signal from an A/D conversion IC is referred to as “capture”. The primary imaging section captures the primary image and outputs the primary image signal, and the secondary imaging section captures the secondary image and outputs the secondary image signal.

The present exemplary embodiment has described the example where a CCD is employed for each of the primary imaging element and secondary imaging element. However, the primary imaging element and secondary imaging element may be any imaging elements as long as they convert the received light into an electric signal, and may be CMOSs (complementary metal oxide semiconductors) or the like, for example.

ROM (read only memory) 222 is configured so that various data such as a program and parameter for operating CPU 220 is stored in ROM 222 and CPU 220 can optionally read the data. ROM 222 is formed of a non-volatile semiconductor memory element, and the stored data is kept even if the power supply of imaging apparatus 110 is turned off.

Input device 224 is a generic name for an input device configured to receive a command of the user. Input device 224 includes various buttons such as a power supply button and setting button, a touch panel, and a lever that are operated by the user. In the present exemplary embodiment, an example where the touch panel is disposed on display 225 is described. However, input device 224 is not limited to these configurations. For example, input device 224 may include a voice input device. Alternatively, input device 224 may have a configuration where all input operations are performed with a touch panel, or a configuration where a touch panel is not disposed and all input operations are performed with a button or a lever.

CPU (central processing unit) 220 is configured to operate based on a program or parameter that is read from ROM 222 or a command of the user that is received by input device 224, and to perform the control of whole imaging apparatus 110 and various arithmetic processing. The various arithmetic processing includes image signal processing related to the primary image signal and secondary image signal. The details of the image signal processing are described later.

In the present exemplary embodiment, a microcomputer is used as CPU 220. However, CPU 220 may be configured to perform a similar operation using an FPGA (field programmable gate array) instead of the microcomputer.

RAM (random access memory) 221 is formed of a volatile semiconductor memory element. RAM 221 is configured to, based on a command from CPU 220, temporarily store a part of the program for operating CPU 220, a parameter during execution of the program, and a command of the user. Data stored in RAM 221 is optionally readable by CPU 220, and is optionally rewritable in response to the command of CPU 220.

Acceleration sensor 223 is a generally used acceleration detection sensor, and is configured to detect the motion and attitude change of imaging apparatus 110. For example, acceleration sensor 223 detects whether imaging apparatus 110 is kept in parallel with the ground, and the detection result is displayed on display 225. Therefore, the user can judge, by watching the display, whether imaging apparatus 110 is kept in parallel with the ground, namely imaging apparatus 110 is in a state (attitude) appropriate for capturing a stereoscopic image. Thus, the user can capture a stereoscopic image or shoot stereoscopic video while keeping imaging apparatus 110 in an appropriate attitude.

Imaging apparatus 110 may be configured to perform the optical control such as a shake correction based on the detection result by acceleration sensor 223. Acceleration sensor 223 may be a gyroscope of three axial directions (triaxial gyro-sensor), or may have a configuration where a plurality of sensors are used in combination with each other.

Display 225 is formed of a generally used liquid crystal display panel, and is mounted on monitor 113 of FIG. 1. Display 225 includes the touch panel attached on its surface, and is configured to simultaneously perform the image display and the reception of a command from the user. Images displayed on display 225 include the following images:

(1) an image being captured by imaging apparatus 110 (image based on the image signal that is output from primary imaging unit 200 or secondary imaging unit 210);

(2) an image based on the image signal that is stored in storage device 227;

(3) an image based on the image signal that is signal-processed by CPU 220; and
(4) a menu display screen for displaying various set items of imaging apparatus 110.

On display 225, these images are selectively displayed or a plurality of images are displayed in an overlapping state. Display 225 is not limited to the above-mentioned configuration, but may be a thin image display device of low power consumption. For example, display 225 may be formed of an EL (electro luminescence) panel or the like.

Encoder 226 is configured to encode, in a predetermined method, an image signal based on the image captured by imaging apparatus 110, or information related to the captured image. This is for the purpose of reducing the data amount stored in storage device 227. The encoding method is a generally used image compression method, for example, MPEG (motion picture experts group)-2 or H. 264/MPEG-4 AVC.

Storage device 227 is formed of a hard disk drive (HDD) as a storage device that is optionally rewritable and has a relatively large capacity, and is configured to readably store the data or the like encoded by encoder 226. The data stored in storage device 227 includes the image signal of a stereoscopic image generated by CPU 220 and the information required for displaying the stereoscopic image. Storage device 227 may be configured to store the image signal that is output from primary imaging unit 200 or secondary imaging unit 210 without applying the encoding processing to it. Storage device 227 is not limited to the HDD. For example, storage device 227 may be configured to store data in an attachable/detachable storage medium such as a memory card having a built-in semiconductor memory element or optical disc.

[1-2. Operation]

The operation of imaging apparatus 110 having such a configuration is described.

In the present exemplary embodiment, the operation when stereoscopic video is shot by primary imaging unit 200 and secondary imaging unit 210 of imaging apparatus 110 is described hereinafter. Therefore, especially when a notice is not given, both the primary image and secondary image are set as moving images. When a stereoscopic image (still image) is captured by imaging apparatus 110, both the primary image and secondary image are still images. In this case, the operation related to the conversion of the frame rate (described later) is not performed.

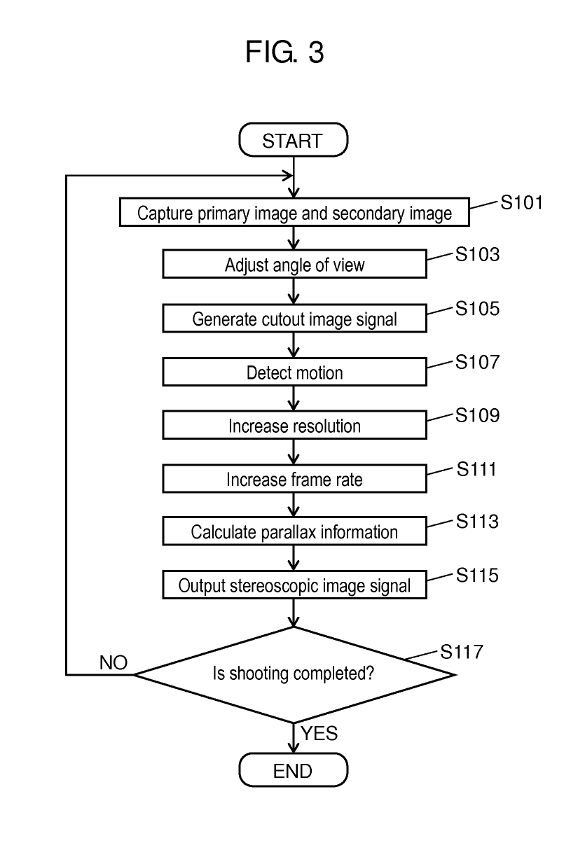

FIG. 3 is a flowchart illustrating the operation when stereoscopic video is shot by imaging apparatus 110 in accordance with the first exemplary embodiment.

When stereoscopic video is shot, imaging apparatus 110 mainly performs the following operation.

Primary imaging unit 200 outputs a primary image signal, and secondary imaging unit 210 outputs a secondary image signal (step S101).

A part corresponding to the range (angle of view) captured as the primary image is cut out from the secondary image signal (step S103), and a cutout image signal is generated (step S105).

Motion detection is performed for each of the primary image signal and cutout image signal (step S107).

The resolution of the primary image signal is increased based on the cutout image signal (step S109).

The frame rate of the cutout image signal is increased in response to the frame rate of the primary image signal (step S111).

Parallax information is generated based on the primary image signal having the increased resolution and the cutout image signal having the increased frame rate (step S113).

Based on the parallax information, a new secondary image signal is generated from the primary image signal having the increased resolution. A stereoscopic image signal in which the primary image signal having the increased resolution is set as a right-eye image signal and the new secondary image signal is set as a left-eye image signal is output (or, is stored in storage device 227) (step S115).

A series of operations are repeated until the user commands the completion of the video shooting (step S117).

The “angle of view” means a range captured as an image, and is expressed generally as an angle.

A main operation performed when stereoscopic video is shot by imaging apparatus 110 is described while each function is shown by each block. How the image signal is processed in each function block is shown in drawings while one example is taken.

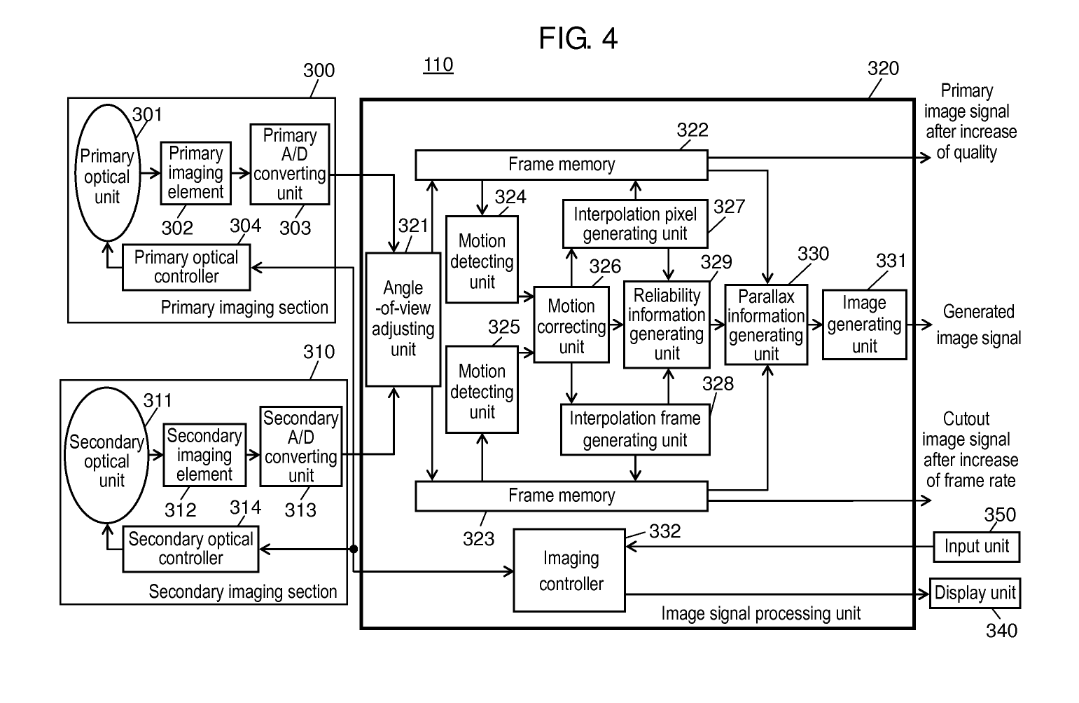

FIG. 4 is a diagram showing the configuration of imaging apparatus 110 in accordance with the first exemplary embodiment while each function is shown by each block.

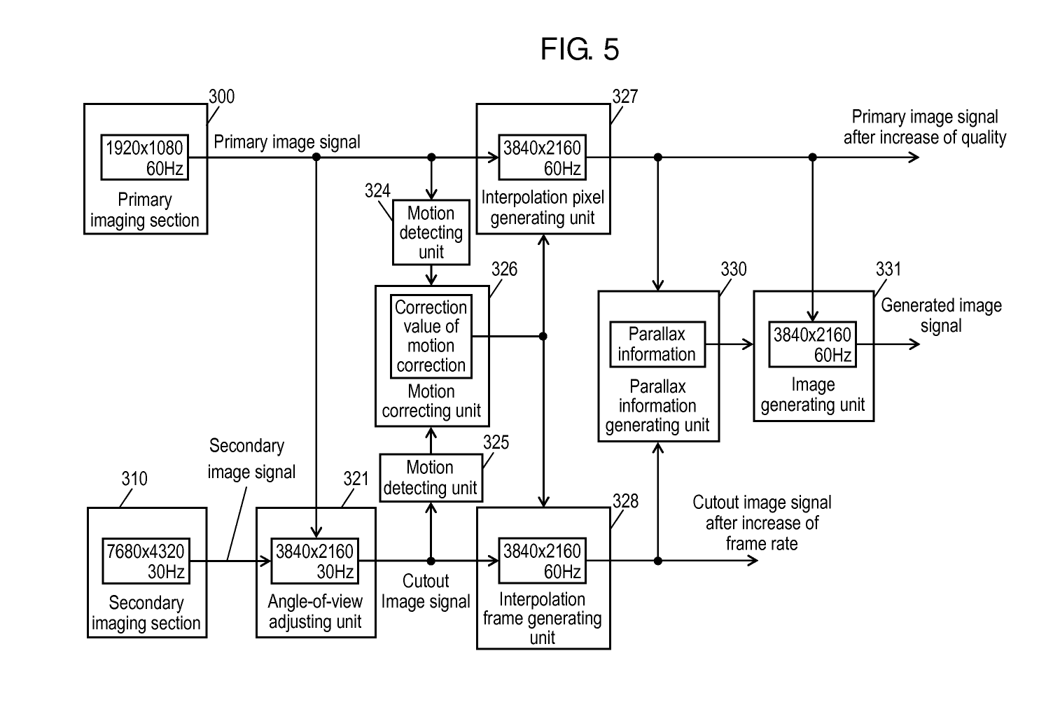

FIG. 5 is a diagram schematically showing one example of the processing flow of an image signal in imaging apparatus 110 in accordance with the first exemplary embodiment.

When the configuration of imaging apparatus 110 is divided into main functions operating during the shooting of stereoscopic video, imaging apparatus 110 can be mainly divided into five blocks: primary imaging section 300, secondary imaging section 310, image signal processing unit 320, display unit 340, and input unit 350, as shown in FIG. 4.

Primary imaging section 300 includes primary optical unit 301, primary imaging element 302, primary A/D converting unit 303, and primary optical controller 304. Primary imaging section 300 corresponds to primary imaging unit 200 shown in FIG. 2. Primary optical unit 301 corresponds to primary lens group 201, primary imaging element 302 corresponds to primary CCD 202, primary A/D converting unit 303 corresponds to primary A/D conversion IC 203, and primary optical controller 304 corresponds to primary actuator 204. In order to avoid the repetition, the descriptions of these components are omitted.

Secondary imaging section 310 includes secondary optical unit 311, secondary imaging element 312, secondary A/D converting unit 313, and secondary optical controller 314. Secondary imaging section 310 corresponds to secondary imaging unit 210. Secondary optical unit 311 corresponds to secondary lens group 211, secondary imaging element 312 corresponds to secondary CCD 212, secondary A/D converting unit 313 corresponds to secondary A/D conversion IC 213, and secondary optical controller 314 corresponds to secondary actuator 214. In order to avoid the repetition, the descriptions of these components are omitted.

Hereinafter, as shown in FIG. 5 as an example, the following description is performed assuming that primary imaging section 300 outputs the primary image signal in which the number of pixels is 1920×1080 and the frame rate is 60 Hz, and secondary imaging section 310 outputs the secondary image signal in which the number of pixels is 7680×4320 and the frame rate is 30 Hz.

The numerical values shown in FIG. 5 are simply one example. The present exemplary embodiment is not limited to the numerical values.

Display unit 340 corresponds to display 225 shown in FIG. 2. Input unit 350 corresponds to input device 224 shown in FIG. 2. A touch panel included in input unit 350 is attached on the surface of display unit 340, and display unit 340 can simultaneously perform the display of an image and the reception of a command from the user. In order to avoid the repetition, the descriptions of these components are omitted.

Image signal processing unit 320 corresponds to CPU 220 shown in FIG. 2.

CPU 220 performs the control of whole imaging apparatus 110 and various arithmetic processing. In FIG. 4, however, only main functions are described while the functions are classified into respective blocks. The main functions are related to the arithmetic processing (image signal processing) and control operation that are performed by CPU 220 when stereoscopic video is shot by imaging apparatus 110. The functions related to the other operations are omitted. This is for the purpose of intelligibly describing the operations when stereoscopic video is shot by imaging apparatus 110.

The function blocks shown in image signal processing unit 320 in FIG. 4 simply indicate main functions of the arithmetic processing and control operation performed by CPU 220. The inside of CPU 220 is not physically divided into the function blocks shown in FIG. 4. For the sake of convenience, however, the following description is performed assuming that image signal processing unit 320 includes the units shown in FIG. 4.

CPU 220 may be formed of an IC or FPGA including an electronic circuit corresponding to each function block shown in FIG. 4.

As shown in FIG. 4, image signal processing unit 320 includes angle-of-view adjusting unit 321, frame memories 322 and 323, motion detecting units 324 and 325, motion correcting unit 326, interpolation pixel generating unit 327, interpolation frame generating unit 328, reliability information generating unit 329, parallax information generating unit 330, image generating unit 331, and imaging controller 332.

Angle-of-view adjusting unit 321 receives a primary image signal output from primary imaging section 300 and a secondary image signal output from secondary imaging section 310. Angle-of-view adjusting unit 321 then extracts, from the input image signals, a part where respective capturing ranges are determined to overlap each other.

Primary imaging section 300 can perform capturing with an optical zoom function, and secondary imaging section 310 performs capturing with a single focus lens. When the imaging sections are set so that the angle of view of the primary image when primary optical unit 301 is set at a wide end is narrower than or equal to the angle of view of the secondary image, the range taken in the primary image is always included in the range taken in the secondary image.

Therefore, angle-of-view adjusting unit 321 extracts, from the secondary image signal, a part corresponding to the range (angle of view) captured as the primary image. Hereinafter, an image signal extracted from the secondary image signal is referred to as “cutout image signal”, and an image corresponding to the cutout image signal is referred to as “cutout image”. Therefore, the cutout image is an image existing in the range that is determined, by angle-of-view adjusting unit 321, to be equal to the capturing range of the primary image.

The procedure in specifying the range that is extracted as the cutout image signal from the secondary image signal is described using drawings.

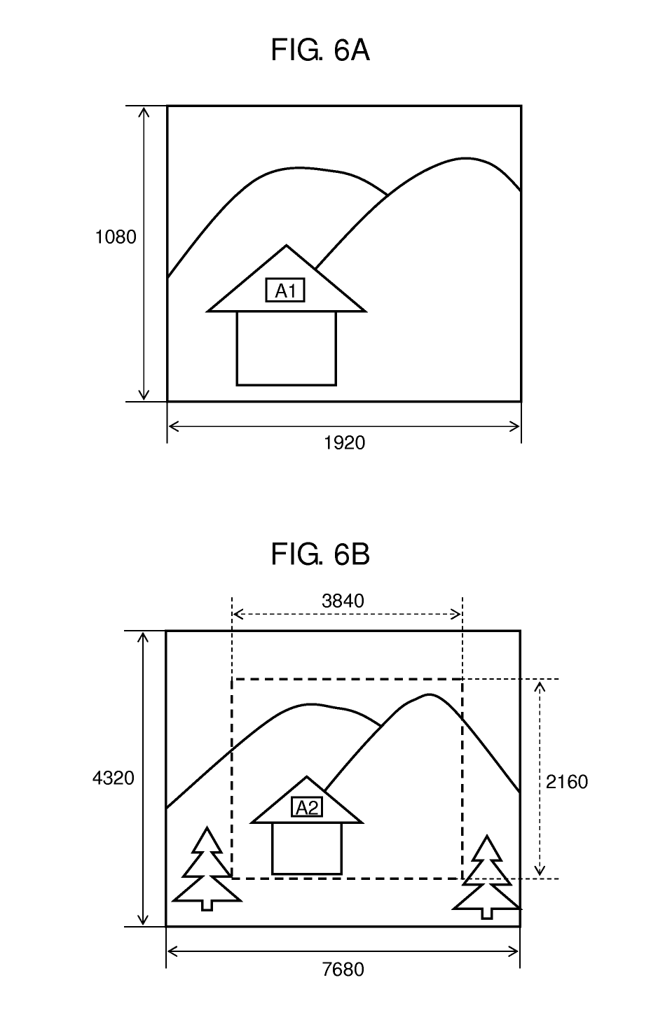

FIG. 6A is a diagram showing one example of the primary image captured by imaging apparatus 110 in accordance with the first exemplary embodiment. FIG. 6B is a diagram showing one example of the secondary image captured by imaging apparatus 110 in accordance with the first exemplary embodiment.

FIG. 6A shows the primary image captured in a state where the zoom magnification of the optical zoom function of primary optical unit 301 is increased. As shown in FIG. 6A and FIG. 6B, the angle of view of the secondary image captured without optical zoom is wider than that of the primary image captured at the increased zoom magnification, and a range larger than that of the primary image is captured in the secondary image.

Imaging controller 332 of image signal processing unit 320 controls the optical zoom of primary optical unit 301 via primary optical controller 304. Therefore, image signal processing unit 320 can acquire, as additional information of the primary image, the zoom magnification of primary optical unit 301 when the primary image is captured. In secondary optical unit 311, the optical zoom is not allowed, and hence the zoom magnification when the secondary image is captured is fixed. Based on this information, angle-of-view adjusting unit 321 calculates the difference between the angle of view of the primary image and that of the secondary image. Based on the calculation result, angle-of-view adjusting unit 321 identifies and cuts out, from the secondary image signal, the region corresponding to the capturing range (angle of view) of the primary image.

At this time, angle-of-view adjusting unit 321 firstly cuts out a range that is slightly larger than the region corresponding to the angle of view of the primary image (for example, a range larger by about 10%). This is because a fine displacement can occur between the center of the primary image and that of the secondary image.

Next, angle-of-view adjusting unit 321 applies a generally used pattern matching to the cutout range, and identifies the region corresponding to the capturing range of the primary image and cuts out the region again. Thus, a cutout image signal can be generated at a relatively high speed by arithmetic processing of a relatively low load. The method such as pattern matching of comparing two images having different angles of view and resolutions with each other and identifying the overlap region between the capturing ranges is a generally known method, and hence the descriptions are omitted.

Thus, angle-of-view adjusting unit 321 extracts, from the secondary image signal, the region substantially equal to the capturing range of the primary image signal, and generates the cutout image signal. In the example shown in FIG. 6A and FIG. 6B, the region having 3840×2160 pixels that is surrounded with a broken line of FIG. 6B is the cutout region. The frame rate of the cutout image signal is the same frame rate (e.g. 30 Hz) as that of the secondary image signal, as shown in FIG. 5.

The difference (parallax) between the disposed position of primary optical unit 301 and that of secondary optical unit 311 causes a difference between the position of the subject in the primary image and that in the secondary image. Therefore, the possibility that the region in the secondary image corresponding to the primary image completely coincides with the primary image is low. Therefore, when angle-of-view adjusting unit 321 performs pattern matching, preferably, the secondary image signal is searched for the region most similar to the primary image signal, the region is extracted from the secondary image signal and set as a cutout image signal.

Angle-of-view adjusting unit 321 then outputs the cutout image signal and primary image signal to the subsequent stage. When the angle of view of the primary image is equal to that of the secondary image, the secondary image signal is sometimes used as a cutout image signal without change.

The operation of angle-of-view adjusting unit 321 is not limited to the above-mentioned operation. When the angle of view of the primary image is wider than that of the secondary image, an operation may be performed in which a region corresponding to the capturing range of the secondary image is extracted from the primary image signal and a cutout image signal is generated. When there is a difference between the capturing range of the primary image and that of the secondary image, regions having the same capturing range may be extracted from the primary image signal and secondary image signal, and may be output to the subsequent stage.

In the present exemplary embodiment, the method used for comparing the primary image signal with the secondary image signal in angle-of-view adjusting unit 321 is not limited to the pattern matching. A cutout image signal may be generated using another comparing/collating method.

The cutout image signal (for example, an image signal having 3840×2160 pixels shown in FIG. 6B) output from angle-of-view adjusting unit 321 is stored in frame memory 323, the primary image signal (for example, an image signal having 1920×1080 pixels shown in FIG. 6A) is stored in frame memory 322.

At this time, each image signal has a generation time (capturing time) of each pixel as additional information. In a global shutter method (a method in which all light receiving elements included in an imaging section simultaneously receive light during the capturing of one image), the generation times (capturing times) of the pixels are substantially the same. However, in a rolling shutter method (a method in which light receiving elements arranged in a matrix shape in an imaging section sequentially receive light from one side to the other side during the capturing of one image), the generation times (capturing times) vary depending on the disposed positions of the pixels. Therefore, when one or both of the primary image and secondary image are captured in the rolling shutter method, a difference can occur between the generation times (capturing times) of the primary image and secondary image even when the same subject is captured.

The difference between the generation times (capturing times) is described using a drawing.

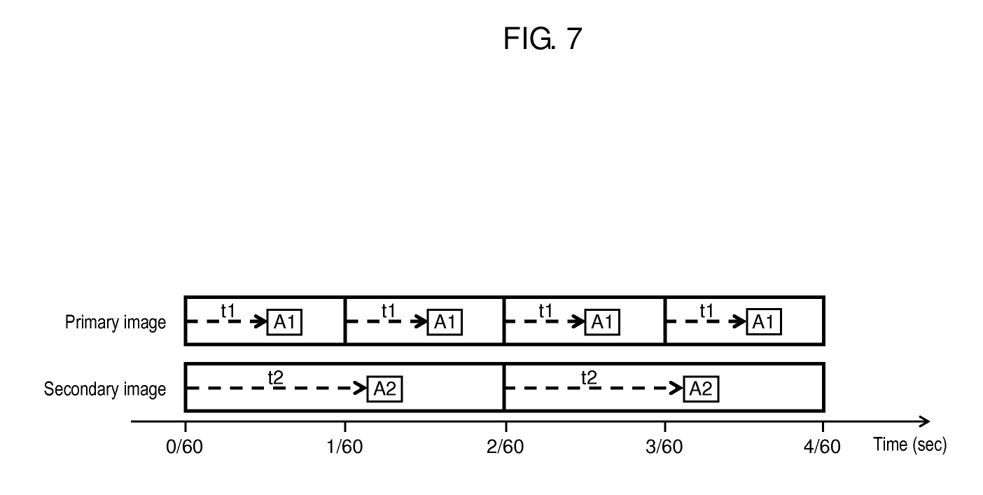

FIG. 7 is a diagram schematically showing the difference between the pixel generation times of the primary image and secondary image that are captured by imaging apparatus 110 in accordance with the first exemplary embodiment.

The following description is performed assuming that the primary image is a moving image shot at a frame rate of 60 Hz, the secondary image is a moving image shot at a frame rate of 30 Hz, and both of the primary image and secondary image are captured in the rolling shutter method. The pixel denoted with “A1” in FIG. 7 indicates the pixel denoted with “A1” in FIG. 6A, and the pixel denoted with “A2” in FIG. 7 indicates the pixel denoted with “A2” in FIG. 6B. It is assumed that the pixel denoted with “A1” and the pixel denoted with “A2” indicate substantially the same subject (region), and correspond to each other. Each of pixels “A1” and “A2” is surrounded with a rectangular frame in FIG. 6A and FIG. 6B, but these rectangular frames are used for the sake of convenience. A pixel existing in the center of each frame is each of pixels “A1” and “A2”.

The number of pixels in the primary image is smaller than that in the secondary image, so that the region corresponding to one pixel in the primary image corresponds to a plurality of pixels in the secondary image. However, for the sake of convenience, it is assumed that pixel “A1” corresponds to pixel “A2”.

Time t1 required before pixel “A1” occurs in the first primary image (which is started to be captured at time 0/60 sec) while primary images are captured is shorter than time t2 required before pixel “A2” occurs in the first secondary image (which is started to be captured at time 0/60 sec) while secondary images are captured. When the frame rate of the primary images is 60 Hz and the frame rate of the secondary images is 30 Hz, two primary images are captured during the capturing of one secondary image. Therefore, substantially, t2=2×t1.

Therefore, depending on the position of pixel “A2”, the generation time of pixel “A1” in the second primary image (which is started to be captured at time 1/60 sec) is temporally closer to the generation time of pixel “A2” than the generation time of pixel “A1” in the first primary image.

Thus, when two images of different frame rates are compared with each other, the generation time of each pixel is important. Therefore, in the present exemplary embodiment, the generation time (capturing time) of each pixel as additional information is stored together with the image signals in the frame memory.

Frame memories 322 and 323 are storage devices for image signals configured to readably store image signals corresponding to a plurality of frames, and are formed of semiconductor memory elements such as a DRAM (dynamic RAM) operable at a high speed. Frame memories 322 and 323 may be disposed inside CPU 220, but a part of RAM 221 may be used as frame memories 322 and 323.

A configuration may be employed where the generation time (capturing time) of each pixel is used as the additional information of each pixel. However, a configuration may be also employed where a generation time (capturing time) is added only to the first pixel and the generation times (capturing time) of the subsequent pixels are calculated based on the generation sequence from the first pixel.

Motion detecting unit 324 performs a motion detection based on the primary image signal stored in frame memory 322. Motion detecting unit 325 performs a motion detection based on the secondary image signal stored in frame memory 323.

Motion detecting units 324 and 325 determine whether each pixel is still or moving by one-pixel matching, or determine whether each block is still or moving by block matching that is based on a set of a plurality of pixels. Regarding a pixel or block determined to be moving, the region near the pixel or block is searched, and an optical flow or motion vector (ME: motion estimate) is detected. The motion detection itself is a generally known method, so that the detailed descriptions are omitted.

Motion correcting unit 326 obtains the motion detection result related to the primary image signal that is output from motion detecting unit 324 and the motion detection result related to the cutout image signal that is output from motion detecting unit 325, and calculates a correction value for motion correction on the basis of the motion detection results. This correction value may be determined from the addition average of two motion detection results, may be determined from the maximum value or minimum value of two motion detection results, or may be determined by the other method. In the present exemplary embodiment, based on the correction value, the motion correction of the primary image signal and cutout image signal is performed.

Interpolation pixel generating unit 327 compares the primary image signal with the cutout image signal, and generates an interpolation pixel for increasing the resolution of the primary image. Interpolation pixel generating unit 327 compares each pixel or block in the primary image signal with the corresponding pixel or block in the cutout image signal, and generates an interpolation pixel signal for increasing the resolution of the primary image signal on the basis of the cutout image signal. The generated interpolation pixel signal is inserted into the corresponding place of the primary image signal, and the primary image signal is modified so that an unnatural region is not caused by the interpolation, thereby increasing the resolution of the primary image signal.

Thus, the resolution of the primary image signal is increased to substantially the same resolution as that of the cutout image signal. For example, in the example of FIG. 5, by the resolution increasing processing, the primary image signal having 1920×1080 pixels is corrected to an image signal that has 3840×2160 pixels and the same resolution as that of the cutout image signal.

Preferably, interpolation pixel generating unit 327 is configured to, when it compares the primary image signal with the cutout image signal, refer to the generation time (capturing time) of each pixel added to each of these image signals, and perform the comparison between pixels or blocks temporally nearest to each other. Interpolation pixel generating unit 327 may be configured to compare the primary image signal with a cutout image signal having undergone the motion correction that is based on the correction value calculated by motion correcting unit 326, and generate a more accurate interpolation pixel signal.

Interpolation frame generating unit 328 reads the cutout image signal stored in frame memory 323 at a speed twice the speed when it is written into frame memory 323. Thus, the one-frame period of the read cutout image signal is shortened from 1/30 sec to 1/60 sec. Furthermore, based on the cutout image signal and the correction value for motion correction that is output from motion correcting unit 326, interpolation frame generating unit 328 generates an interpolation image signal (interpolation frame) to be inserted between two temporally continuous cutout image signals.

Thus, the frame rate of the cutout image signal is increased to substantially the same frame rate as that of the primary image signal. For example, in the example of FIG. 5, the cutout image signal having a frame rate of 30 Hz is corrected to an image signal having a frame rate of 60 Hz by this frame rate increasing processing.

The primary image signal whose resolution is increased by interpolation pixel generating unit 327 is stored again in frame memory 322, and the cutout image signal whose frame rate is increased by interpolation frame generating unit 328 is stored again in frame memory 323.

The method of motion correcting, the method of increasing the resolution of an image signal by generating an interpolation pixel, and the method of increasing the frame rate of the image signal by generating an interpolation frame are generally known methods, so that detailed descriptions are omitted.

Reliability information generating unit 329 generates reliability information for each pixel, using the generation time (capturing time) of each pixel that is added to the image signal and the correction value for motion correction that is output from motion correcting unit 326. For example, in the example of FIG. 7, the reliability for each pixel is increased as t2 approaches twice as long as t1. As the correction value for motion correction for each pixel is decreased, the reliability for each pixel is increased. The obtained reliability is reliability information.

In reliability information generating unit 329, reliability information may be added to each pixel, but reliability information may be added to each block consisting of a plurality of adjacent pixels.

Parallax information generating unit 330 generates parallax information based on a primary image signal having an increased resolution and a cutout image signal having an increased frame rate. Parallax information generating unit 330 compares the primary image signal having the increased resolution with the cutout image signal having the increased frame rate, and calculates, for each pixel or each block consisting of a plurality of pixels, the displacement between a subject on the primary image signal and the corresponding subject on the cutout image signal. This “displacement amount” is calculated in the parallax direction, namely in the direction parallel to the ground when the capturing is performed, for example. Parallax information (depth map) is generated by calculating the “displacement amount” in the whole region of one image and associating the “displacement amount” with a pixel or block of the image as the calculation object. Here, the one image is an image based on the primary image signal having the increased resolution or an image based on the cutout image signal having the increased frame rate.

Imaging apparatus 110 generates, from a primary image signal (e.g. right-eye image signal) having the increased resolution, an image signal (e.g. left-eye image signal) paired with the primary image signal on the basis on the parallax information. Therefore, by correcting the parallax information, the stereoscopic effect of the generated stereoscopic image can be adjusted. Parallax information generating unit 330 may be configured to correct the parallax information so that adjustment of the stereoscopic effect such as increasing or suppressing of the stereoscopic effect of the stereoscopic image can be performed.

For example, the parallax information may be corrected based on the reliability information. For example, by correcting the parallax information so that the stereoscopic effect of an image of low reliability is decreased, the quality of the generated stereoscopic image can be increased.

Parallax information generating unit 330 may be configured to reduce the number of pixels (signal amount) by thinning out pixels of the image signal used for comparison, and to reduce the operation amount required for calculating the parallax information.

Parallax information generating unit 330 can accurately generate the parallax information also for a moving subject by performing processing such as stereoscopic matching on the basis of the image signal after the motion correction.

Image generating unit 331, based on the parallax information output from parallax information generating unit 330, generates a new secondary image signal (referred to as “generated image signal” in FIG. 4 and FIG. 5) from the primary image signal having the increased resolution. This new secondary image signal is generated as an image signal that has the same specification as that of the primary image signal having the increased resolution. For example, in FIG. 5, the new secondary image signal is generated as an image signal having 3840×2160 pixels and a frame rate of 60 Hz.

In the present exemplary embodiment, image signal processing unit 320 outputs the stereoscopic image signal in which the right-eye image signal is set to be the primary image signal having the increased resolution and the left-eye image signal is set to be the new secondary image signal that is generated based on the parallax information by image generating unit 331.

This stereoscopic image signal is stored in storage device 227, for example, and the stereoscopic image based on the stereoscopic image signal is displayed on display unit 340.

The method of calculating parallax information (displacement amount) from two images having parallax and the method of generating a new image signal based on the parallax information are publicly known, and are described in Patent Literature 1, for example. Therefore, detailed descriptions are omitted.

Preferably, the zoom magnification of primary optical unit 301 and the resolution of secondary imaging element 312 are set so that the resolution of the cutout image signal when primary optical unit 301 is set at a telescopic end is higher than or equal to the resolution of the primary image signal. This is for the purpose of preventing the possibility that, when primary optical unit 301 is set at the telescopic end, the resolution of the cutout image signal becomes lower than that of the primary image signal. However, the present exemplary embodiment is not limited to this configuration.

Preferably, secondary optical unit 311 is configured to have an angle of view that is substantially equal to or wider than the angle of view obtained when primary optical unit 301 is set at a wide end. This is for the purpose of preventing the possibility that, when primary optical unit 301 is set at the wide end, the angle of view of the primary image becomes wider than that of the secondary image. However, the present exemplary embodiment is not limited to this configuration. The angle of view of the primary image when primary optical unit 301 is set at the wide end may be wider than that of the secondary image.

[1-3. Effect or the Like]

Thus, in the present exemplary embodiment, imaging apparatus 110 includes the following components:
primary imaging section 300 configured to capture a primary image at a frame rate higher than that of a secondary image signal, and output a primary image signal;
secondary imaging section 310 configured to capture a secondary image having an angle of view wider than that of the primary image at a resolution higher than that of the primary image, and output a secondary image signal; and
image signal processing unit 320.
   Image signal processing unit 320 includes angle-of-view adjusting unit 321, interpolation pixel generating unit 327, interpolation frame generating unit 328, parallax information generating unit 330, and image generating unit 331. Angle-of-view adjusting unit 321 is configured to, based on the primary image signal, cut out at least a part of the secondary image signal and generate a cutout image signal. Interpolation pixel generating unit 327 is configured to, based on the primary image signal and cutout image signal, generate an interpolation pixel for increasing the resolution of the primary image signal. Interpolation frame generating unit 328 is configured to generate an interpolation frame for increasing the frame rate of the cutout image signal. Parallax information generating unit 330 is configured to generate parallax information based on the following image signals:
the primary image signal whose resolution is increased using the interpolation pixel; and
the cutout image signal whose frame rate is increased using the interpolation frame.
   Image generating unit 331 is configured to, based on the parallax information, generate a new image signal from the primary image signal having the increased resolution.

In order to acquire (generate) a high-quality stereoscopic image, it is preferable that, when a right-eye image and left-eye image are captured in a pair, the capturing condition such as the angle of view (capturing range), resolution (number of pixels), and zoom magnification is aligned between the images and is set constant as much as possible between the images.

However, the characteristic when light is converted into an electric signal is apt to differ between imaging elements. Therefore, even when imaging elements having the same specification are compared with each other, the gamma characteristic or the like indicating the relationship between the brightness and output signal can differ between the imaging elements. Therefore, even when a pair of imaging sections are formed of optical systems and imaging elements having the same functions (performances), the brightness, contrast, and white balance can differ between the right-eye image and left-eye image used in a pair.

Thus, even when a pair of imaging sections having the same specification are formed, it is difficult to acquire a right-eye image and left-eye image that have completely the same state except the parallax.

Furthermore, in order to acquire (generate) high-quality stereoscopic video, it is preferable that a right-eye image and left-eye image are video-shot in a pair at the same frame rate.

In imaging apparatus 110 of the present exemplary embodiment, however, the optical specification of primary imaging section 300 is different from that of secondary imaging section 310, as discussed above. The specification of the imaging element in primary imaging section 300 is different from that in secondary imaging section 310. Furthermore, the frame rate during the video shooting also differs between primary imaging section 300 and secondary imaging section 310.

In imaging apparatus 110, therefore, even when the primary image captured by primary imaging section 300 is used as the right-eye image without change and the secondary image captured by secondary imaging section 310 is used as the left-eye image without change, it is difficult to acquire a high-quality stereoscopic image (stereoscopic video).

In the present exemplary embodiment, therefore, imaging apparatus 110 is configured as discussed. In other words, the primary image captured by primary imaging section 300 is set as the right-eye image after the resolution of the primary image is increased. An image that is generated, using the parallax information, from the primary image having the increased resolution is set as the left-eye image. Thus, a stereoscopic image (stereoscopic video) is generated.

This method can generate a right-eye image and left-eye image that are substantially the same as the right-eye image and left-eye image that are captured (or video-shot) by a pair of ideal imaging sections. Here, the ideal imaging sections have the same imaging condition such as optical characteristic, gamma characteristic, and frame rate. Therefore, imaging apparatus 110 of the present exemplary embodiment can generate high-quality stereoscopic video.

The parallax information is generated by comparing the primary image and secondary image with each other. When the accuracy of the parallax information generated at this time is not high, it is difficult to increase the quality of the image generated based on the parallax information.

In order to accurately generate the parallax information, it is important to accurately perform the comparison between the primary image and secondary image. For the purpose of the accurate comparison, preferably, the angle of view (capturing range), resolution (number of pixels), and frame rate are constant as much as possible between the images to be compared with each other.

In the present exemplary embodiment, therefore, imaging apparatus 110 is configured as discussed, a cutout image signal is generated from the secondary image signal on the basis of the primary image signal, and the frame rate of the cutout image signal is increased depending on the frame rate of the primary image signal. The resolution of the primary image signal is increased depending on the resolution of the cutout image signal.

Then, the parallax information is generated using the primary image signal whose resolution is increased and the cutout image signal whose frame rate is increased.

Thus, imaging apparatus 110 can generate accurate parallax information, and can generate a high-quality stereoscopic image (stereoscopic video) on the basis of the high-quality parallax information.

### Other Exemplary Embodiments

Thus, the first exemplary embodiment has been described as an example of a technology disclosed in the present application. However, the disclosed technology is not limited to this exemplary embodiment. The disclosed technology can be applied to exemplary embodiments having undergone modification, replacement, addition, or omission. A new exemplary embodiment may be created by combining the components described in the first exemplary embodiment.

Another exemplary embodiment is described hereinafter.

The present exemplary embodiment has described the example where imaging apparatus 110 is configured so that primary imaging section 300 captures a primary image and secondary imaging section 310 captures a secondary image. However, imaging apparatus 110 may be configured to include a primary image input unit instead of primary imaging section 300, include a secondary image input unit instead of secondary imaging section 310, acquire a primary image with the primary image input unit, and acquire a secondary image with the secondary image input unit, for example.

The present exemplary embodiment has described the following configuration:
a primary image captured by primary imaging section 300 is set as a right-eye image after the resolution of the primary image is increased;
an image that is generated, using the parallax information, from the primary image having the increased resolution is set as a left-eye image; and
a stereoscopic image (stereoscopic video) is generated.
   However, the following configuration may be employed, for example:
a primary image captured by primary imaging section 300 is set as a left-eye image after the resolution of the primary image is increased;
an image that is generated, using the parallax information, from the primary image having the increased resolution is set as a right-eye image; and
a stereoscopic image (stereoscopic video) is generated.
   Alternatively, a configuration may be employed where a new primary image signal is generated from a cutout image signal whose frame rate is increased.

Primary optical unit 301 (primary lens group 201) and secondary optical unit 311 (secondary lens group 211) are not limited to the configuration shown in the first exemplary embodiment. For example, instead of the focus lens adjustable in focus, a deep-focus lens requiring no focus adjustment may be employed. Secondary optical unit 311 may include an optical diaphragm for adjusting the quantity of the light that is received by secondary imaging element 312 (secondary CCD 212).

Secondary optical unit 311 may include an optical zoom lens instead of the single focus lens. In this case, for example, when a stereoscopic image (stereoscopic video) is captured by imaging apparatus 110, secondary optical unit 311 may be automatically set at a wide end.

Imaging apparatus 110 may be configured so that, when primary optical unit 301 is set at a telescopic end, the cutout image signal has a resolution lower than that of the primary image signal. In this case, for example, interpolation pixel generating unit 327 may be configured to increase the resolution of the primary image signal to a value higher than that of the cutout image signal on the basis of the correction value or the like of the motion correction that is output from motion correcting unit 326. Alternatively, imaging apparatus 110 may be configured so that, when the resolution of the cutout image signal becomes lower than or equal to that of the primary image signal in an increasing process of the zoom magnification of primary optical unit 301, the capture mode is automatically switched from a stereoscopic image to a normal image.

Interpolation pixel generating unit 327 may be configured so that, when the resolution of the cutout image signal becomes lower than or equal to a predetermined resolution, the resolution of the primary image signal is increased to the predetermined resolution regardless of the resolution of the cutout image signal. Furthermore, interpolation pixel generating unit 327 may be configured so that, even when the resolution of the cutout image signal is higher than or equal to the predetermined resolution, the resolution of the primary image signal is increased to the predetermined resolution and is kept at it, a right-eye image signal (or left-eye image signal) is generated always at the same resolution (predetermined resolution). In this case, the state occurs where the resolution (number of pixels) of the primary image signal having the increased resolution is different from that of the cutout image signal. Therefore, parallax information generating unit 330 may be configured to generate parallax information after a number-of-pixels correction such as the following operation:
the number of pixels in one of the primary image signal having the increased resolution and the cutout image signal is decreased to the number of pixels in the other; or
the numbers of pixels in both signals are equalized.

The disposed position of secondary lens unit 112 is not limited to the position shown in FIG. 1, but may be set at any position as long as a stereoscopic image can be captured. For example, secondary lens unit 112 may be disposed near primary lens unit 111.

Imaging apparatus 110 may have the following configuration:
imaging apparatus 110 includes a switch that is turned on when monitor 113 is opened to a position appropriate for capturing a stereoscopic image, and is turned off in the other cases; and
a stereoscopic image can be captured or stereoscopic video can be shot only when the switch is turned on.

In imaging apparatus 110, the primary image signal whose resolution is increased may be used as a single image signal, and the cutout image signal (or secondary image signal) whose frame rate is increased may be used as a single image signal. Alternatively, a primary image signal output from primary imaging section 300 may be used as it is and a secondary image signal output from secondary imaging section 310 may be used as it is.

The specific numerical values of the exemplary embodiments are simply one example of the exemplary embodiments. The present disclosure is not limited to these numerical values. Preferably, each numerical value is set at an optimal value in accordance with the specification or the like of the image display device.

The present disclosure is applicable to an imaging apparatus that includes a plurality of imaging units and can capture an image for stereoscopic vision. Specifically, the present disclosure is applicable to a digital video camera, a digital still camera, a mobile phone having a camera function, or a smartphone.

What is claimed is:

1. An image generating apparatus comprising:
an angle-of-view adjusting unit configured to receive a primary image signal and a secondary image signal and to, based on the primary image signal, cut out at least a part from the secondary image signal and generate a cutout image signal, the secondary image signal having a resolution higher than a resolution of the primary image signal and an angle of view wider than or equal to an angle of view of the primary image signal;
an interpolation pixel generating unit configured to generate an interpolation pixel for increasing the resolution of the primary image signal;
a parallax information generating unit configured to generate parallax information based on the primary image signal, whose resolution is increased using the interpolation pixel, and the cutout image signal; and
an image generating unit configured to, based on the parallax information, generate a new image signal from the primary image signal whose resolution is increased.

2. The image generating apparatus of claim 1, further comprising an interpolation frame generating unit,
wherein the angle-of-view adjusting unit is configured to receive the primary image signal as a video signal and the secondary image signal as a video signal, the secondary image signal having a resolution higher than the resolution of the primary image signal and a frame rate lower than a frame rate of the primary image signal,
wherein the interpolation frame generating unit is configured to generate an interpolation frame for increasing a frame rate of the cutout image signal, and
wherein the parallax information generating unit is configured to generate the parallax information based on the primary image signal whose resolution is increased and the cutout image signal whose frame rate is increased using the interpolation frame.

3. The image generating apparatus of claim 2, wherein
the interpolation pixel generating unit is configured to generate the interpolation pixel for increasing the resolution of the primary image signal to a resolution substantially equal to a resolution of the cutout image signal, and
the interpolation frame generating unit is configured to generate the interpolation frame for increasing the frame rate of the cutout image signal to a frame rate substantially equal to the frame rate of the primary image signal.

4. An imaging apparatus comprising:
a primary imaging section configured to capture a primary image and output a primary image signal;
a secondary imaging section configured to capture a secondary image at a resolution higher than a resolution of the primary image and output a secondary image signal, the secondary image having an angle of view wider than or equal to an angle of view of the primary image;
an angle-of-view adjusting unit configured to, based on the primary image signal, cut out at least a part from the secondary image signal and generate a cutout image signal;
an interpolation pixel generating unit configured to generate an interpolation pixel for increasing the resolution of the primary image signal;
a parallax information generating unit configured to generate parallax information based on the primary image signal, whose resolution is increased using the interpolation pixel, and the cutout image signal; and
an image generating unit configured to, based on the parallax information, generate a new image signal from the primary image signal whose resolution is increased.

5. The imaging apparatus of claim 4, further comprising an interpolation frame generating unit,
wherein the primary imaging section is configured to output the primary image signal as a video signal,
wherein the secondary imaging section is configured to output the secondary image signal as a video signal, the video signal having a resolution higher than the resolution of the primary image signal and a frame rate lower than a frame rate of the primary image signal,
wherein the interpolation frame generating unit is configured to generate an interpolation frame for increasing a frame rate of the cutout image signal, and
wherein the parallax information generating unit is configured to generate the parallax information based on the primary image signal whose resolution is increased and the cutout image signal whose frame rate is increased using the interpolation frame.

6. The imaging apparatus of claim 5, wherein
the interpolation pixel generating unit is configured to generate the interpolation pixel for increasing the resolution of the primary image signal to a resolution substantially equal to a resolution of the cutout image signal, and
the interpolation frame generating unit is configured to generate the interpolation frame for increasing the frame rate of the cutout image signal to a frame rate substantially equal to the frame rate of the primary image signal.

7. The imaging apparatus of claim 5, wherein
the primary imaging section includes:
a primary optical unit having an optical zoom function; and
a primary imaging element configured to convert light having transmitted through the primary optical unit into an electric signal and, to output the primary image signal,
the secondary imaging section includes:
a secondary optical unit having an angle of view wider than or equal to an angle of view of the primary optical unit; and
a secondary imaging element configured to convert light having transmitted through the secondary optical unit into an electric signal at a resolution higher than a resolution of the primary imaging element and, to output the secondary image signal,
the primary imaging section and the secondary imaging section are configured so that the resolution of the cutout image signal that is generated based on the primary image signal is higher than or equal to the resolution of the primary image signal, the primary image signal being captured when the zoom function is set at a telescopic end, and
the interpolation pixel generating unit is configured to generate the interpolation pixel for increasing the resolution of the primary image signal to a resolution substantially equal to the resolution of the cutout image signal.

8. The imaging apparatus of claim 7, wherein
the secondary optical unit is configured to have an angle of view substantially equal to an angle of view obtained when the primary optical unit is set at a wide end.

9. An image generating method comprising:
cutting out at least a part from a secondary image signal and generating a cutout image signal based on a primary image signal, the secondary image signal having a resolution higher than a resolution of the primary image signal and an angle of view wider than or equal to an angle of view of the primary image signal;
generating an interpolation pixel for increasing the resolution of the primary image signal;
generating parallax information based on the primary image signal, whose resolution is increased using the interpolation pixel, and the cutout image signal; and
generating, based on the parallax information, a new image signal from the primary image signal whose resolution is increased.

10. The image generating method of claim 9, comprising:
receiving the primary image signal as a video signal and the secondary image signal as a video signal, the secondary image signal having a resolution higher than the resolution of the primary image signal and a frame rate lower than a frame rate of the primary image signal;
generating an interpolation frame for increasing a frame rate of the cutout image signal; and
generating the parallax information based on the primary image signal whose resolution is increased and the cutout image signal whose frame rate is increased using the interpolation frame.

11. The image generating method of claim 10, comprising:
generating the interpolation pixel so as to increase the resolution of the primary image signal to a resolution substantially equal to a resolution of the cutout image signal; and
generating the interpolation frame so as to increase the frame rate of the cutout image signal to a frame rate substantially equal to the frame rate of the primary image signal.
